(19) United States
(12) Patent Application Publication
(10) Pub. No.: US 2022/0318827 A1
(43) Pub. Date: Oct. 6, 2022

(54) SYSTEM AND METHODOLOGY FOR DETERMINING RECOMMENDED TRANSFER AMOUNTS IN DYNAMIC LIGHTWEIGHT PERSONALIZED ANALYTICS

(71) Applicant: Sandra K. Johnson, Cary, NC (US)

(72) Inventor: Sandra K. Johnson, Cary, NC (US)

(21) Appl. No.: 17/701,903

(22) Filed: Mar. 23, 2022

Related U.S. Application Data
(60) Provisional application No. 63/169,032, filed on Mar. 31, 2021.

(51) Int. Cl. G06Q 30/02; G06Q 10/06

(52) U.S. Cl. CPC G06Q 30/0201; G06Q 10/06393; G06Q 30/0205

(57) ABSTRACT

Exemplary embodiments include a feedback-based system and methodology for suggesting or making special transfer recommendations in dynamic lightweight personalized analytics (DLPA). It focuses on when and how to make such transfers, and the actual transfer amounts, based on remittance customer behavior, local and global events, geolocation data and other relevant information. Exemplary embodiments include a process for identifying, minimizing, and leveraging the behavioral information that optimize customer satisfaction in conjunction with the key performance indicators (KPIs) used in quantifying success. Furthermore, it facilitates a small memory footprint and optimal computation in selecting such donations.

### CROSS REFERENCE TO RELATED APPLICATIONS

This application claims priority to U.S. Provisional Application 63/169,032, filed Mar. 31, 2021, the contents of which are incorporated herein in its entirety.

This application relates to U.S. patent application Ser. No. 16/914,629, filed Jun. 29, 2020, which claims priority to U.S. Provisional Application No. 62/868,950, filed Jun. 30, 2019, and U.S. patent application Ser. No. 17/013,895, filed Sep. 8, 2020, which claims priority to U.S. Provisional Application 62/897,360, filed Sep. 8, 2019, and U.S. patent application Ser. No. 17/084,778, filed Oct. 30, 2020, which claims priority to U.S. Provisional Application 62/927,872, filed Oct. 30, 2019 and U.S. patent application Ser. No. 17/137,677, filed Dec. 30, 2020, which claims priority to U.S. Provisional Application No. 62/922,244, filed Dec. 30, 2019, and U.S. patent application Ser. No. 17/194,746, filed Mar. 8, 2021, which claims priority to U.S. Provisional Application No. 62/986,754, filed Mar. 8, 2020, and U.S. patent application Ser. No. 17/215,750, filed Mar. 29, 2021, which claims priority to U.S. Provisional Application No. 63/000,864, filed Mar. 27, 2020, U.S. patent application Ser. No. 17/365,080, filed Jul. 1, 2021, which claims priority to U.S. Provisional Application No. 63/047,326, filed Jul. 2, 2020, U.S. patent application Ser. No. 17/538,182, filed Nov. 30, 2021, which claims priority to U.S. Provisional Application No. 63/119,550, filed Nov. 30, 2020, U.S. patent application Ser. No. 17/558,838, filed Dec. 22, 2021, which claims priority to U.S. Provisional Application No. 63/129,820, filed Dec. 23, 2020, and U.S. patent application Ser. No. 17/690,449, filed Mar. 9, 2022, which claims priority to U.S. Provisional Application No. 63/161,121, filed Mar. 15, 2021, the contents of which are incorporated herein in its entirety.

### FIELD OF DISCLOSURE

The disclosed teachings relate generally to determining the minimal set of customer behavior and other relevant information needed to select special transfer recommendation amounts in a relationship-based remittance service. In addition, it focuses on leveraging a small footprint to gain personalized insights used to optimize customer satisfaction based on such transfers. Potential participants include not only those in consumer-focused industries and entities, but also any entity that benefits from analytics-based suggestions for optimizing relatively small amounts of data for specific actions using fast computational times.

### BACKGROUND

Many consumer-based companies leverage customer behavior data and associated predictive, prescriptive, and other analytic methodologies to gain insights. Such information can translate into suggestions to improve efficiencies, understand trends, optimize customer objectives, create new potential markets, build customer relationships, or discover or prevent fraud, to name a few. There is an abundance of analytics efforts conducted to gain such insights. With an increasingly consumer-centric society, there is a growing focus on behavioral analytics to understand customer preferences that can translate into market gains. Much of this work leverages a plethora of structured and unstructured data, big data, that may be siloed and geographically dispersed for insights.

However, there are many consumer-focused industries that require or benefit from small, lightweight, and fast analytics. For example, the prevailing focus in the remittance industry is the transfer of funds from sender to receiver. The transfer amounts are small, and users require minimal transfer times. With thin industry profit margins, the remittance industry requires all efforts to assist in transferring funds are efficient, lightweight, and fast. In this and many other industries, there are no significant efforts to build customer relationships, understand their preferences, needs and behaviors, and build customer loyalty leveraging small data or lightweight analytics. A study has shown that businesses that develop strong customer connections outperform their competitors by 85% in sales growth and more than 25% in gross margins (“Behavioral Economics,” Gallup, Gallup.com).

Proposed is a system and methodology for recommending or making special transfer amounts in dynamic lightweight personalized analytics (DLPA). It focuses on when and how to make or recommend such transfers based on remittance customer behavior, local and global events, geolocation data, and other relevant information. Such transfers are made to optimize customer satisfaction and other key performance indicators (KPIs) used in quantifying success for remittance services. DLPA is a new innovative technology designed to provide individual analytics to gain insights for developing personalized offerings and building relationships with the customer. DLPA leverages a limited number of customer-specific, industry-focused input parameters, and other inputs such as customer behavior, support, and a small memory footprint. These parameters are placed in data structures to assist in processing DLPA-related actions. This invention focuses on suggesting or making special transfer amounts, both statically or dynamically, by leveraging customer behavior or other events. It is based on customer behavior and other metrics used in DLPA to optimize desirable outcomes. It relates to U.S. patent application Ser. Nos. 16/914,629, 17/013,895, 17/084,778, 17/137,677, 17/194,746, 17/215,750, 17/365,080, 17/538,182, 17/558,838 and 17/690,449.

There are some efforts to use analytics in the remittance industry. For example, Remit Radar's Galileo (https://remitradar.com/Home/Galileo) uses analytics to understand global remittance market trends. Lexis Nexis (http://threatmetrixx.com) and others use analytics to discover glitches or behavior anomalies and detect and prevent fraud. Most focus on overall trends and patterns, not individual behaviors, to gain insights for unique customer offerings. To our knowledge, there are no efforts to develop dynamic lightweight personalized analytics methodologies to gain insights for customized services real time. This would be a significant game-changer, for example, in the $550B+ global cross-border remittance industry.

### SUMMARY

Embodiments of the present disclosure provide a system for selecting transfer amounts associated with events in dynamic lightweight personalized analytics (DLPA), the system comprising: an interface that receives one or more inputs via an enterprise payment services bus; a data storage unit comprising a customer account database and a trends database, wherein the customer account database is further configured to store at least account profiles, support data, DLPA metrics, and key performance indicators (KPIs); and a remittance analytics engine comprising a computer processor and coupled to the data storage unit and the interface, the computer processor configured to determine when to transfer an amount of funds in conjunction with the occurrence of an event, the determination comprising the following steps: First, the processor sets a group of metrics to their default values, the values comprising: a default recommended transfer amount (df_rec) and a default recommended transfer amount for a special event (sp_df_rec). Next, the processor compares the metrics against their default values for a predetermined time window (dTW). Next, the processor proceeds with calculating a new set of key performance indicators (KPIs). Next, the processor determines whether a regular event or special event has occurred. Next, the processor determines, upon finding that a regular event has occurred, whether to transfer a recommended amount of funds to a recipient upon any one of the following being true: (1) the previous actual transfer amount for a regular event (act_xfer) is not less than the recommended transfer amount for a regular event (rec), and (2) the default recommended transfer amount (df_rec) is not less than the recommended transfer amount for a regular event (rec). Next, the processor sets, upon a determination to transfer a recommended amount of funds to a recipient in response to the regular event, the previous actual transfer amount for a regular event (act_xfer) to be equal to the recommended transfer amount for a regular event (rec). Then, the processor transfers, upon setting the act_xfer equal to the rec, the recommended amount for regular events to the recipient. Next, the processor determines, upon finding that a special event has occurred, whether to transfer a recommended amount of funds to a recipient upon any one of the following being true: (1) a previous actual transfer amount for a special event (spec_xfer) is not less than a recommended transfer amount for a special event (spec), and (2) the default recommended transfer amount for a special event (sp_df_rec) is not less than the recommended transfer amount for a special event (spec); Then, the processor sets, upon a determination to transfer a recommended amount of funds to a recipient in response to the special event, the previous actual transfer amount for a special event (spec_xfer) equal to a recommended transfer amount for a special event (spec). Next, the processor transfers, upon setting the spec_xfer equal to the spec, the recommended amount for special events to the recipient. Then, the processor executes, upon a determination that neither a regular event or special event has occurred, the comparison in a different time window (dTW).

Embodiments of the present disclosure also provide a method, the method comprising the following steps: First, the processor sets a group of metrics to their default values, the values comprising: a default recommended transfer amount (df_rec) and a default recommended transfer amount for a special event (sp_df_rec). Next, the processor compares the metrics against their default values for a predetermined time window (dTW). Next, the processor proceeds with calculating a new set of key performance indicators (KPIs). Next, the processor determines whether a regular event or special event has occurred. Next, the processor determines, upon finding that a regular event has occurred, whether to transfer a recommended amount of funds to a recipient upon any one of the following being true: (1) the previous actual transfer amount for a regular event (act_xfer) is not less than the recommended transfer amount for a regular event (rec), and (2) the default recommended transfer amount (df_rec) is not less than the recommended transfer amount for a regular event (rec). Next, the processor sets, upon a determination to transfer a recommended amount of funds to a recipient in response to the regular event, the previous actual transfer amount for a regular event (act_xfer) to be equal to the recommended transfer amount for a regular event (rec). Then, the processor transfers, upon setting the act_xfer equal to the rec, the recommended amount for regular events to the recipient. Next, the processor determines, upon finding that a special event has occurred, whether to transfer a recommended amount of funds to a recipient upon any one of the following being true: (1) a previous actual transfer amount for a special event (spec_xfer) is not less than a recommended transfer amount for a special event (spec), and (2) the default recommended transfer amount for a special event (sp_df_rec) is not less than the recommended transfer amount for a special event (spec); Then, the processor sets, upon a determination to transfer a recommended amount of funds to a recipient in response to the special event, the previous actual transfer amount for a special event (spec_xfer) equal to a recommended transfer amount for a special event (spec). Next, the processor transfers, upon setting the spec_xfer equal to the spec, the recommended amount for special events to the recipient. Then, the processor executes, upon a determination that neither a regular event or special event has occurred, the comparison in a different time window (dTW).

Embodiments of the present disclosure also provide a system for associating recommended transfers with key performance indicators (KPIs), the system comprising: an interface that receives one or more inputs via an enterprise payment services bus; a data storage unit comprising a customer account database and a trends database, wherein the customer account database is further configured to store at least account profiles, support data, DLPA metrics, and key performance indicators (KPIs); and a remittance analytics engine comprising a computer processor and coupled to the data storage unit and the interface, the computer processor configured to associate recommended transfers with KPIs, the determination comprising the following steps: First, the processor sets a group of relevant metrics to their default values. Then, the processor executes an analysis of the KPIs over a predetermined time window (dTW). Next, the processor proceeds with calculating, within dTW, a new set a KPIs. Next, the processor determines whether at least X number of KPIs are favorable, wherein X is a default parameter. Next, the processor proceeds with executing, upon a determination that at least X number of KPIs are favorable, a process for making recommendations associated with transfers between a sender and recipient. Next, the processor proceeds with executing, upon a determination that less than X number of KPIs are favorable, an analysis of the KPIs over a different dTW.

Embodiments of the present disclosure also provide a method for associating recommended transfers with key performance indicators (KPIs), the methods comprising the following steps: First, the processor sets a group of relevant metrics to their default values. Then, the processor executes an analysis of the KPIs over a predetermined time window (dTW). Next, the processor proceeds with calculating, within dTW, a new set a KPIs. Next, the processor determines whether at least X number of KPIs are favorable, wherein X is a default parameter. Next, the processor proceeds with executing, upon a determination that at least X number of KPIs are favorable, a process for making recommendations associated with transfers between a sender and recipient. Next, the processor proceeds with executing, upon a determination that less than X number of KPIs are favorable, an analysis of the KPIs over a different dTW.

### BRIEF DESCRIPTION OF THE DRAWINGS

FIG. 1 is a block diagram of a remittance payments service-oriented architecture, in accordance with exemplary embodiments of the disclosure.

FIG. 2 is a block diagram of a remittance data storage, in accordance with exemplary embodiments of the disclosure.

FIG. 3 is a block diagram of the types of data stored in a remittance data storage, in accordance with exemplary embodiments of the disclosure.

FIG. 4 is a block diagram of the partial contents of a remittance data store, in accordance with exemplary embodiments of the disclosure.

FIG. 5 is a block diagram of the dynamic lightweight personalized analytics (DLPA) engine, including special transfer suggestions, in accordance with exemplary embodiments of the disclosure.

FIGS. 6A, 6B, and 6C are flowcharts illustrating an exemplary method for determining the recommended transfer amounts for events.

FIG. 7 is a flowchart illustrating an exemplary method for associating recommended transfers with key performance indicators (KPIs).

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

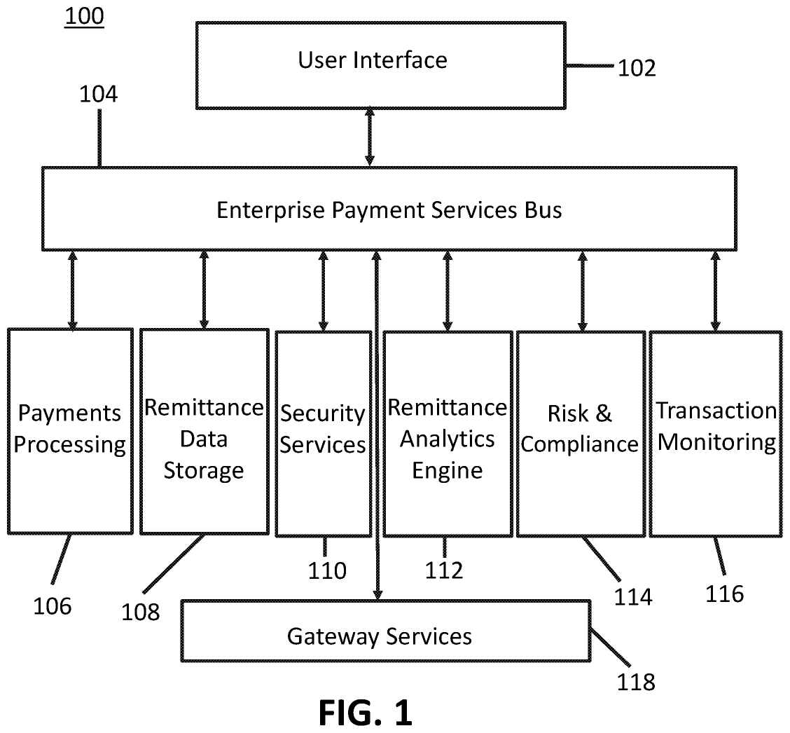

FIG. 1 is a schematic block diagram illustrating one embodiment of the service-oriented architecture (SOA) 100 of a remittance system designed to process transactions, in accordance with one embodiment of the present invention. The system 100, in one embodiment, includes a user interface 102 that enables a user to send or receive requests. This user interface 102 interacts with the enterprise payments services bus 104 to request or receive services. The enterprise payments services bus 104 may be configured to transmit data between engines, databases, memories, and other components of the system 100 for use in performing the functions discussed herein.

The enterprise payments services bus 104 may be comprised of one or more communication types and utilize various communication methods for communications within a computing device. For example, the enterprise payments services bus 104 may be comprised of a bus, contact pin connectors, wires, etc. In some embodiments, the enterprise payments services bus 104 may also be configured to communicate between internal components of system 100 and external components accessible through gateway services 118, such as externally connected databases, display devices, input devices, etc.

There are several services that may compose this SOA 100, including payments processing 106, remittance data storage 108, security services 110, the remittance analytics engine 112, risk and compliance 114, transaction monitoring 116, and gateway services 118, which are described below. Each of these service components may be software, a computer-readable program, executing on one of more processors, and may include a mainframe computer, a workstation, a desktop computer, a computer in a smart phone, a computer system in a rack, a computer system in a cloud, a physical system, a virtual system, and the like.

The system 100, in one embodiment, is the SOA of a remittance system and is a network of software service components in which the illustrative embodiments may be implemented. The system 100 includes a user interface 102 used by a consumer. The consumer represents a person, a software program, a virtual program, or any other entity that has possession of, can emulate, or other otherwise issue commands to execute transactions in the system 100. The system 100 includes an enterprise payment services bus 104 which accepts and processes commands from the user interface 102 and other system components. It also enables communication among the various services components in the system 100.

As a part of executing a remittance request, the transaction may leverage payments processing 106 to process the request. Such processing may also include the creation and funding of financial accounts associated with a recipient. The transaction may also access remittance data storage 108 which is a resource for data access. Security services 110 are also leveraged to ensure the full security and integrity of funds and data, and to detect and prevent fraud. In addition, the remittance analytics engine 112 is leveraged and is the foundation for DLPA. This engine takes as input a plethora of information from the remittance data storage 108 and other components that may enable the remittance analytics engine 112 to optimize its outputs. The risk and compliance services 114 provide customer identification, verification, and other similar services required to comply with relevant governmental regulations and to minimize risk. The transaction monitoring 116 service tracks funds transfer behavior and other activities to detect anomalies that may point to fraud. It works in concert with security services 110.

Gateway services 118 enable the transfer of funds, data, requests, etc. to externally connected entities for further processing. Such entities may include a computer network, a financial institution, and others that may participate in end-to-end remittance or other funds transfer or data services. Other similar embodiments will be apparent to persons having skill in the relevant art.

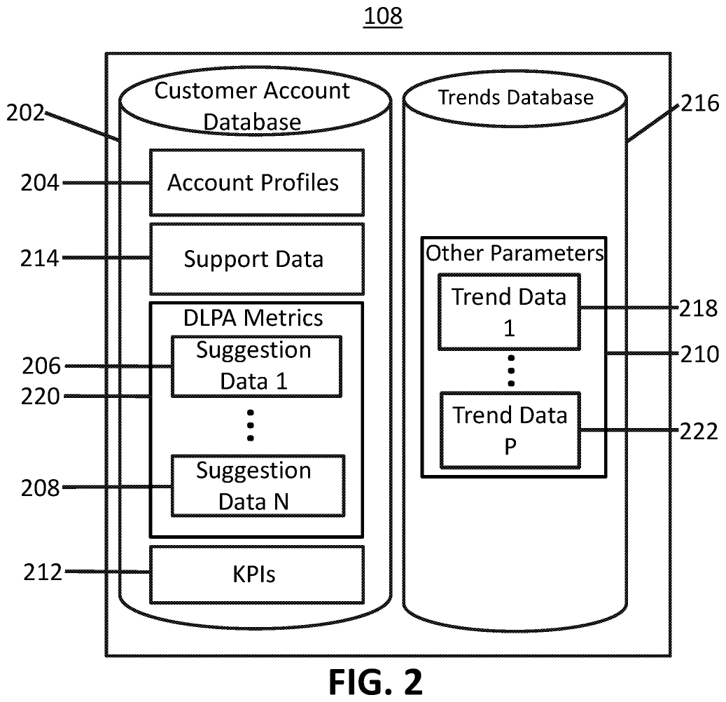

FIG. 2 is a schematic block diagram illustrating one embodiment of the remittance data storage service 108 used in the processing of information requests. The remittance data storage 108 may be a relational database, or a collection of relational databases, that utilizes structured query language for the storage, identification, modifying, updating, accessing, etc. of structured data sets stored therein. This data storage 108 is composed of a customer account database 202 that contains customer account and other related customer information. The customer account database 202 may be configured to store a plurality of consumer account profiles 204 as well as a plurality of DLPA metrics 220, including suggestions to customers 206 and 208, using a suitable data storage format and schema. The customer account database 202 also contains support data 214 and key performance indicators (KPIs) 212. Please see a larger list of potential DLPA metrics in the Glossary of Terms. In addition, those skilled in the relevant art will understand this is a representative embodiment. There are other similar metrics that may be used in other embodiments.

Each customer account profile 204 may be a structured data set configured to store data related to a remittance account. Each customer account profile 204 may include at least the customer's full name, address, telephone number, birthdate, birth country, a remittance account number, a bank account number, credit card account information, email address, a list of recipients and associated international mobile telephone numbers, remittance transaction history, a postal mailing address, an email address, and other relevant information. The customer account profile 204 may also include additional information suitable for customer service programs, customer and vendor optimizations, and regulations, such as product data, offer data, loyalty data, reward data, usage data, currency-exchange data, mobile money data, fraud scoring, validity of funds, and transaction/account controls. The customer account profile 204 may also include additional information that may be required for know-your-customer (KYC) and anti-money laundering (AML) regulations. It may further contain information suitable for performing the functions discussed herein, such as communication details for transmitting via the enterprise payment services bus 104.

The suggestion data 206 and 208 may be a wealth of various types of suggestions or recommendations made to the customer and used to quantify success. Such suggestions are included in the Rec-Array with a maximum number of entries, Rec-Array-Max. Example suggestion data include the recommendation acceptance rate (RAR), recommendation impact (RI), recommendation acceptance impact (RAI), financial account acceptance rate (FAR), financial recommendation impact (FRI), financial recommendation acceptance impact (FAI), other recommendation acceptance rate (OAR), other recommendation impact (ORI), other recommendation acceptance impact (OAI) or charitable donations suggestions. Please see a larger list of potential DLPA metrics in the Glossary of Terms. In addition, those skilled in the art will understand this is a representative embodiment. There are other similar metrics that may be used in other embodiments.

Examples of support data 214 stored include the type of support inquiry, how it was resolved, response time, resolution time, frequency of support contact, customer satisfaction data and other similar metrics. Example KPIs 212 are listed in the Glossary of Terms. Some include the total funds transferred per customer, the total number of transfers per customer, the total number of recipients per customer and the total balances in all financial accounts per customer.

Also contained in the remittance data storage 108 is a trends database 216, which includes other parameters 210, including trend data 218 and 222. Examples of other parameters 210 include the LG-Mix, transaction data, customer temperament information, external events, social media data, geolocation data, communications data, recipient data, and milestone events. This data also includes OP-Max, the maximum number of other parameters 210 considered per customer, and OP-Count-Trigger, used to determine when to remove or replace other parameters 210. OP-Max also represents the size of the other parameter 210 array per customer. Both OP-Max and OP-Count-Trigger are default parameters that may be adjusted dynamically.

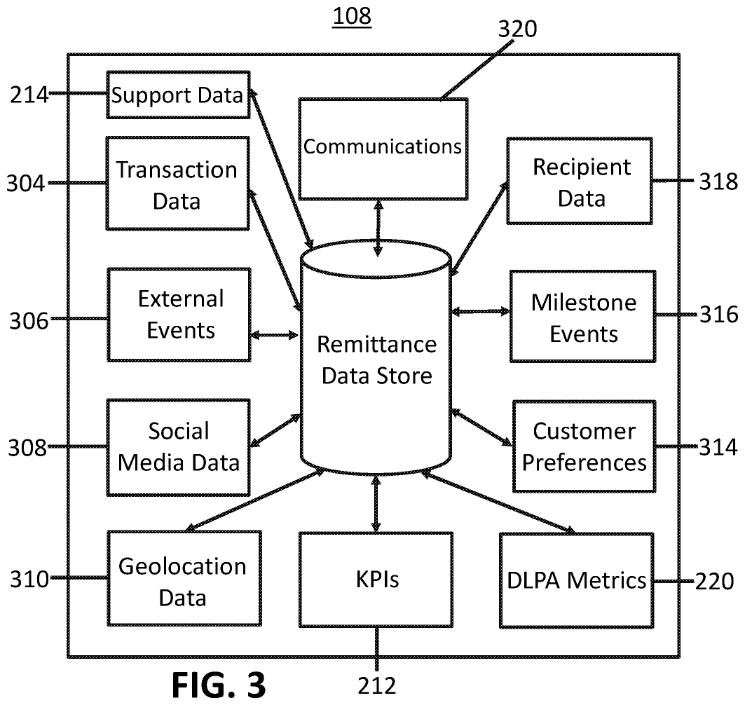

FIG. 3 is a schematic block diagram illustrating one embodiment of specifics regarding the plurality of data that may be stored in the remittance data storage 108. This data may be stored as structured data sets that may include support data 214, transaction data 304, external events data 306, social media data 308, geolocation data 310, KPIs 212, DLPA metrics 220, customer preferences 314, milestone events 316, recipient data 318 and communications data 320.

Example transaction data 304 may include the transfer amount, transfer time, recipient name and international mobile number, the time since the last transfer initiated by the sender to any receiver, the time since the last transfer initiated by the sender to a specific receiver, and the final status of a transaction (e.g., completed, cancelled, etc.). Additional data may include metrics to quantify customer sentiments such as the number of times or frequency that the customer contacted support, time with support, and support outcomes. Example external events 306 include general remittance transaction data (transfer amounts, frequency, etc.) for other customers using the specific remittance service or for remittance customers using any remittance service, public holidays for the sender and receiver countries, natural disasters, immigration policies, the price of oil, global and local recessions.

Example social media data 308 may include posts and other exchanges in Facebook, Twitter, Instagram, LinkedIn, and other similar social media platforms. Example geolocation data 310 may include the physical location of the sender and receiver when the funds transfer is initiated or received or the physical location of the sender or receiver at specific or random times. Other similar embodiments will be apparent to persons having skill in the relevant art.

Example customer preferences 314 are from the perspective of the sender. They may include hobbies, favorite things to do, and financial preferences. Furthermore, DLPA enables the creation of a financial or other account by the customer to save for the future. This account may be created and funded either statically or dynamically. A customer preference 314 may include the customer's desire to create a separate account (or some other activity) based on DLPA analytics, to choose the type of account to create and to determine how to fund the account.

A customer preference 314 may be to create a financial or other account when registering for the remittance service, or upon DLPA recommendations when using the remittance service. Such an account may be targeted for the customer's remittance recipients. A customer may select between a checking, savings, money market, brokerage, or other similar account. The customer may choose the purpose for creating a bank account (e.g., for education, starting a business, donating to a charity or some other option for the sender and/or the receiver). The choices may be general (e.g., the same type of account for sender and each recipient), for each recipient, or variable (e.g., a different type of account depending on the recipient or a group of recipients). Other similar embodiments will be apparent to persons having skill in the relevant art.

Example milestone events 316 may include birthdays, including milestone birthdays (e.g., 18, 25, 30, etc.), weddings, anniversaries, graduations, and other special days for the sender or receiver. Example recipient data 318 may include full name, international telephone number and recipient preferences that are like customer preferences 314. Communications data 320 may include the recent types of communications between sender, receiver, the remittance service provider, and external entities. This includes SMS messages, email, and other communication types. Other similar embodiments will be apparent to persons having skill in the relevant art.

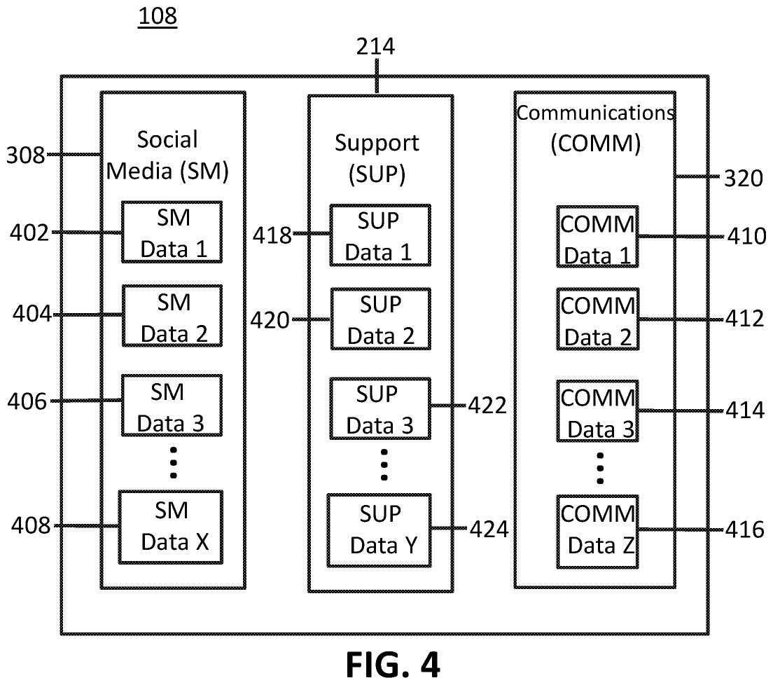

FIG. 4 is a schematic block diagram illustrating one embodiment of partial contents of the remittance data storage 108. It contains a plurality of social media data 308: 402, 404, 406, and 408; support data 214: 418, 420, 422, and 424; and communications data 320: 410, 412, 414, and 416. Associated with each of these types of data is its associated impact, the social media impact, support impact, and communication impact. These metrics are also stored in the remittance data storage 108, but not presented in FIG. 4. Each impact metric is calculated as the fraction of favorable outcomes for social media, support, and communications, respectively, resulting in an increase in at least one KPI in the customer's KPI-Array.

The plurality of social media 308, support 214, and communications data 320 is stored in relevant arrays of size X, Y and Z, respectively. The size of these arrays can vary as detailed in U.S. patent application Ser. No. 17/084,778.

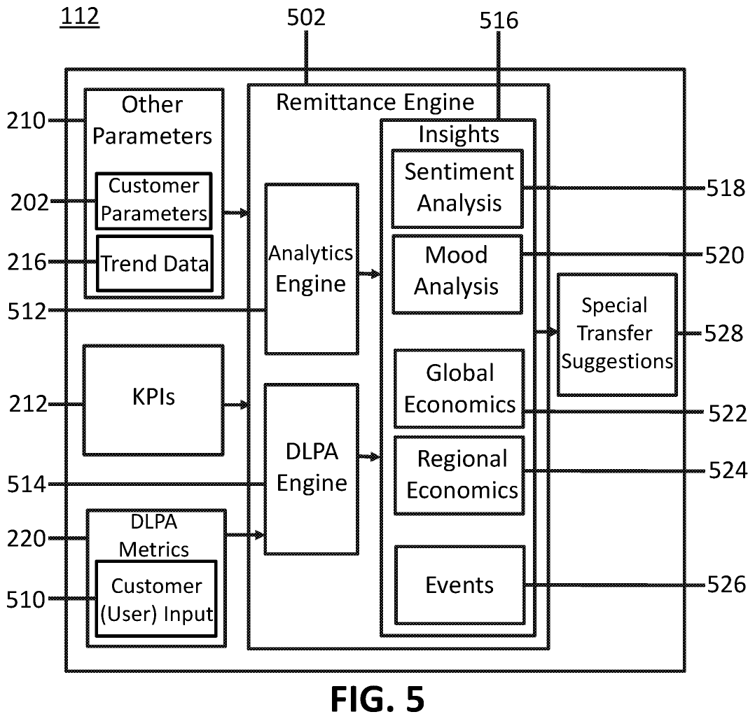

FIG. 5 is a schematic block diagram illustrating one embodiment of the remittance analytics engine 112, the foundation for DLPA. It includes at its core the remittance engine 502, which contains the analytics engine 512, and the DLPA engine 514. The remittance engine 502 accepts customer parameters 202 and remittance trends 216 as input. Customer parameters 202 consist of social media 308, support data 214, and communications 320 as well as other data. They collectively form the other parameters 210 set of inputs. Other input metrics include the KPIs 212. The DLPA engine 514 processes DLPA-related events. It accepts DLPA metrics 220. These metrics 220 are impacted by special transfer suggestions 528. Such information is contained in the customer input data 510, a component of the DLPA metrics 220. Outputs from the analytics engine 512 and DLPA engine 514 are leveraged to provide insights 516 for sentiment analysis 518, mood analysis 520, global 522 and regional 524 economics, and events 526. Such insights 516 are then used to make special transfer suggestions 528 and other similar suggestions.

The remittance engine 502 is the primary computational engine for leveraging predictive, customer behavioral and other analytics techniques for optimal special transfer suggestions 528 for DLPA. It further utilizes a plurality of customer parameters 202, including social media 308, support 214, and communications data 320, remittance trends 216, KPIs 212, and DLPA metrics 220 as input for its calculations.

Special transfer suggestions 528 may include certain types of regular and special events that would trigger recommendations. Example regular events include a birthday, holiday, ZIP code event, good social media posts or customer support, a good economy in the sender's region, favorable KPIs, or other similar events. Special events include a milestone birthday (e.g., 25, 30, 40, 50, etc.), a special holiday for sender or receiver country, a high-income ZIP code event, an excellent rating for support or social media posts, a natural disaster in the recipient's country (while the disaster is not favorable, it may necessitate an increase in the amount of funds to send to the receiver), an undesirable immigration policy, achieving a key customer milestone, 316, or other similar event. The suggestions may be associated with the frequency of achieving such metrics within a given time window, dTW, or a few time windows, #TWs.

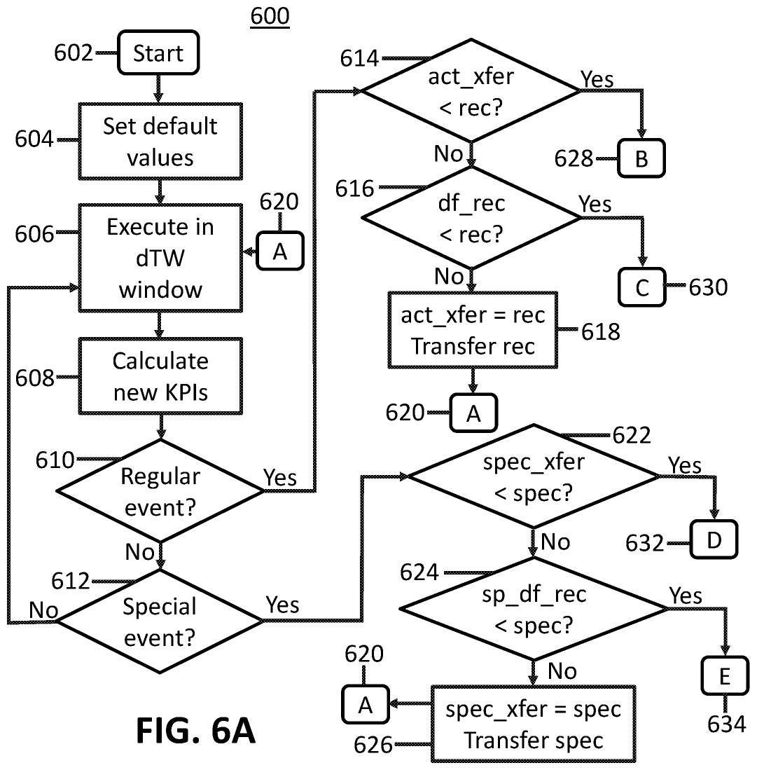

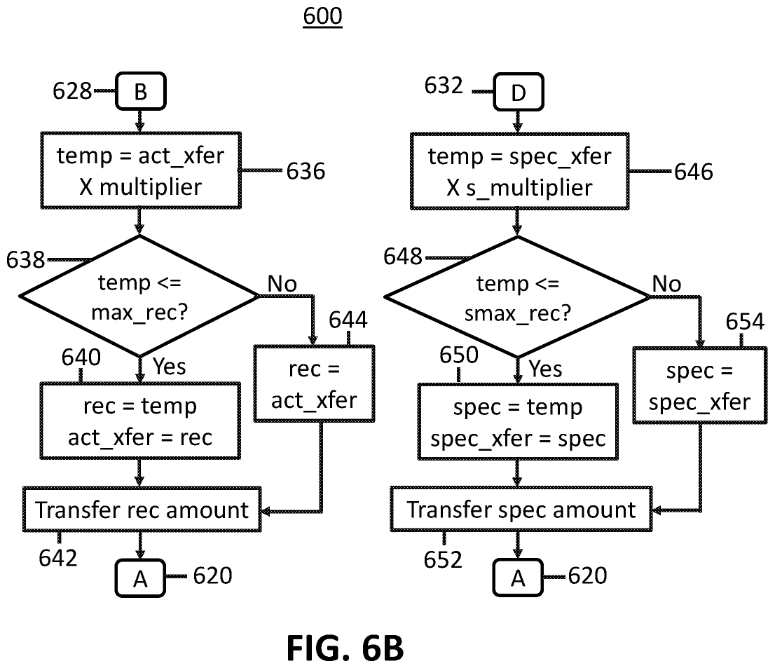

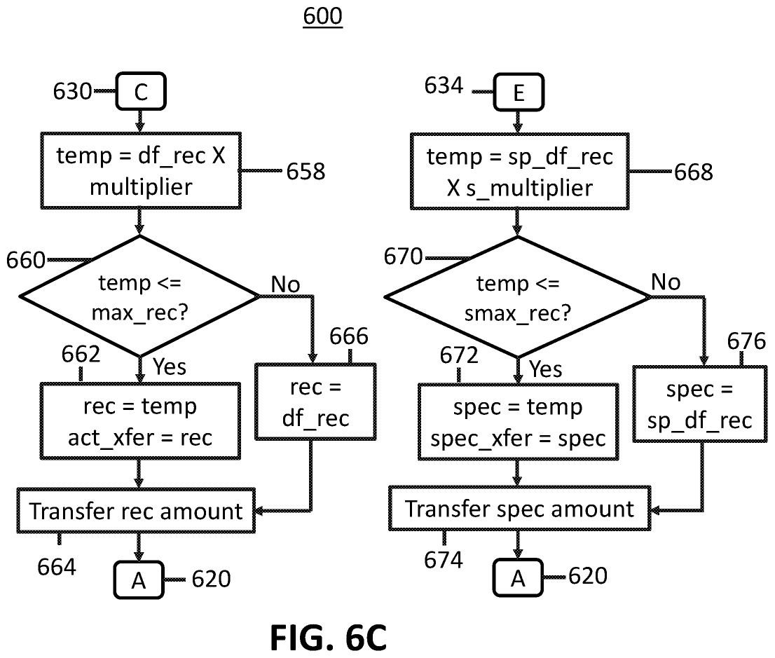

FIG. 6A is a flowchart illustrating an exemplary method for determining the recommended transfer amount for events. The method starts 602 by setting the relevant metrics to their default values 604. Next the method executes for a given time window, dTW 606. Then the new KPIs are calculated 608. Next, a determination is made about whether a regular event has occurred 610. If yes, then the method checks to see if the previous actual transfer amount for a regular event (act_xfer) is less than the recommended transfer amount for a regular event (rec) 614. If yes, then the method goes to the next step 628, which is detailed in FIG. 6B 600. If no, then the method determines if the default recommended transfer amount (df_rec) is less than rec 616. If yes, then the method goes to the next step 630, which is detailed in FIG. 6C 600. If no, then the method sets act_xfer equal to rec, then transfers the recommended amount to the recipient 618. Next, the method goes back 620 to execute in a new time window 606.

If this is not a regular event 610, then the method determines if this is a special event 612. If yes, then the method checks to see of the previous actual transfer amount for a special event (spec_xfer) is less than the recommended transfer amount for a special event (spec) 622. If yes, then the method goes to the next step 632, which is detailed in FIG. 6B 600. If no, then the method determines if the default recommended transfer amount for a special event (sp_df_rec) is less than spec 624. If yes, then the method goes to the next step 634, which is detailed in FIG. 6C 600. If no, then the method sets spec_xfer equal to spec, then transfers the recommended amount for special events to the recipient 626. Next, the method goes back 620 to execute in a new time window 606. If this is not a special event 612, then the method starts execution in a new time window 606.

FIG. 6B is a flowchart illustrating an exemplary method for determining the recommended transfer multiplier and amount for regular 628 and special 632 events if the past actual transfer amounts were less than the recommended transfer amounts. For a regular event, the method starts 628 by calculating a multiple (multiplier) of the actual (past) regular event transfer amount 636. This value, denoted as temp (which equals act_xfer*multiplier) 636, is then compared to the maximum recommended transfer amount for a regular event (max_rec). If the newly calculated multiplier, temp 638, is less than or equal to max_rec 638, then the recommended transfer amount for a regular event is set to this new value, and act_xfer is set to rec 640. If not, then the recommended transfer amount for a regular event is set to act_xfer 644. Next the recommended transfer amount (rec) is transferred to the recipient 642, then the method proceeds to execute in the next time window 620.

For a special event, the method starts 632 by calculating a multiple (s_multiplier) of the actual (past) special event transfer amount, denoted as temp (which equals spec_xfer*s_multiplier) 646. This value, temp 648, is then compared to the maximum recommended transfer amount for a special event (smax_rec). If the newly calculated multiplier, temp 648, is less than or equal to smax_rec 648, then the recommended transfer amount for a special event is set to this new value, temp 650, and spec_xfer is set to spec 650. If not, then the recommended transfer amount for a special event is set to spec_xfer 654. Next the recommended transfer amount (spec) is transferred to the recipient 652, then the method proceeds to the execute in the next time window 620.

FIG. 6C is a flowchart illustrating an exemplary method for determining the recommended transfer multiplier and amount for regular 630 and special 634 events if the default transfer amounts were less than the recommended transfer amounts. For a regular event, the method starts 630 by calculating a multiple (multiplier) of the actual (past) regular event transfer amount, temp (which equals df_rec*multiplier) 658, based on the default recommendation (df_rec) 658. This value, temp 660, is then compared to the maximum recommended transfer amount for a regular event (max_rec). If the newly calculated multiplier, temp 660, is less than or equal to max_rec 660, then the recommended transfer amount for a regular event is set to this new value, temp 662, and act_xfer is set to rec 662. If not, then the recommended transfer amount for a regular event is set to df_rec 666. Next the recommended transfer amount (rec) is transferred to the recipient 664, then the method proceeds to execute in the next time window 620.

For a special event, the method starts 634 by calculating a multiple (s_multiplier) of the actual (past) special event transfer amount, temp (which equals sp_df_rec*s_multiplier) 668, based on the default recommendation (sp_df_rec) 668. This value, temp 670, is then compared to the maximum recommended transfer amount for a special event (smax_rec) 670. If the newly calculated multiplier, temp 670, is less than or equal to smax_rec 670, then the recommended transfer amount for a special event is set to this new value, temp 672, and spec_xfer is set to spec 672. If not, then the recommended transfer amount for a special event is set to sp_df_rec 676. Next the recommended transfer amount for a special event (spec) is transferred to the recipient 674, then the method proceeds to execute in the next time window 620.

Other embodiments of this exemplary method may include distinct values for each type of regular or special event, distinct values for groups of regular or special events, or some permutation thereof. In addition, the embodiments described assume the user accepts recommendations. Other embodiments may show the user not accepting the transfer amount recommendations, but instead choosing another transfer amount that is larger or smaller than the recommended amount. In such instances, the actual transfer amounts are recorded in act_xfer and spec_xfer for regular and special events, respectively. Such embodiments are determined by those skilled in the regular art.

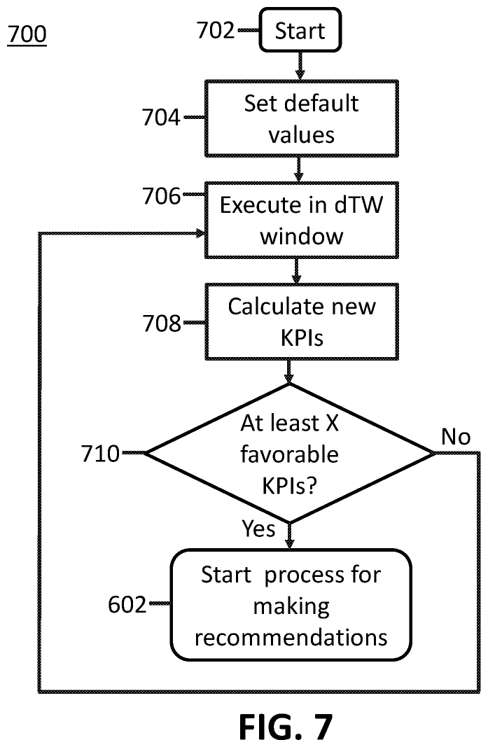

FIG. 7 is a flowchart illustrating an exemplary method for associating recommended transfers with key performance indicators (KPIs). The method starts 702 by setting the relevant metrics to their default values 704. Next the method executes for a given time window, dTW 706. Then the new KPIs are calculated 708. Next, it is determined whether at least X number of KPIs are favorable 710, where X is a default parameter (although it may also vary dynamically). If there is at least X favorable KPIs 710, then the method starts executing the process for making recommendations 602, as illustrated in FIGS. 6A, 6B, and 6C. Otherwise, the method proceeds to execute in the next time window 706.

The embodiments described herein assumes specific parameter default values. Another embodiment is to set the default or recommendation transfer amounts to be a percentage of the average transfer amount, in general or per sender, the average transfer amount to each recipient, in general or per sender, or some other permutation. These embodiments are determined by those skilled in the regular art.

### Glossary of Terms

Algorithm—a set of steps or rules that enables the solution to an issue.
Analytics—a methodology for discovering, understanding, and communicating meaningful patterns in data.
Architecture—the fundamental structures of a system and the associated discipline for creating such structures.
Communications Data—information deriving from the customer's communications, include SMS messages and email.
DLPA Metrics—parameters used in DLPA methodology:
   FAR: financial account acceptance rate; the fraction of all financial account recommendations per customer accepted.
   FRI: financial recommendation impact; fraction of all financial account recommendations resulting in an increase in at least one KPI in KPI-Array.
   FAI: finance recommendation acceptance impact; fraction of all accepted financial account recommendations resulting in an increase in at least one KPI in KPI-Array.
   CIS: Change in Savings is the change in the total savings amounts per customer, or per recipient per customer, between time windows.
Recommendation Parameters:
   df_rec: the default recommended transfer amount for non-special events.
   sp_df_rec: the default recommended transfer amount for special events.
   rec: the recommended transfer amount for non-special events.
   spec: the recommended transfer amount for special events.
   max_rec: the maximum recommended transfer amount for non-special events.
   smax_rec: the maximum recommended transfer amount for special events.
   act_xfer: sender's actual transfer amount for non-special events, in response to a recommendation.
   spec_xfer: sender's actual transfer amount for special events, in response to a recommendation.
   multiplier: the multiplier used in recommended non-special event transfers.
   s_multiplier: the multiplier used in recommended special event transfers.
   temp: a value equal to some transfer amount multiplied by a predetermined multiplier.
Key Performance Indicators (KPIs):
   TFT: Total funds transferred per customer (sender).
   TFT-Min: the minimum value for TFT.
   TNT: Total number of transfers per customer.
   TB: Total balances in all financial accounts per customer.
   TB-Min: the minimum value for TB.
   NR: Total number of recipients per customer.
   NFA: Total number of financial accounts per customer.
   KPI-Array: a collection the KPIs of focus per customer.
   KPI-Max: the maximum number of KPIs considered per customer.
   KPI-Count-Trigger: used to determine when to remove or replace a KPI.
LG-Mix—a fraction of all DLPA suggestions (local and global) that are local.
Other Parameters—DLPA parameter and trend data described in U.S. patent application Ser. No. 16/914,629. Examples include the LG-Mix, transaction data, external events, social media data, geolocation data, communications data, recipient data, milestone events, trend data, etc.
dTW—default time window, the given time frame for calculating parameters, making decisions #TW−number of time windows.
max_TWs—trigger for maximum number of time windows before a reset.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

1. A system for selecting transfer amounts associated with events in dynamic lightweight personalized analytics (DLPA), the system comprising:
an interface that receives one or more inputs via an enterprise payment services bus;
a data storage unit comprising a customer account database and a trends database, wherein the customer account database is further configured to store at least account profiles, support data, DLPA metrics, and key performance indicators (KPIs); and
a remittance analytics engine comprising a computer processor and coupled to the data storage unit and the interface, the computer processor configured to perform an analysis to determine when to transfer an amount of funds in conjunction with an occurrence of an event, the analysis comprising:
setting a group of metrics to their default values, the values comprising: a default recommended transfer amount (df_rec) and a default recommended transfer amount for a special event (sp_df_rec);
comparing, by the processor, the metrics against their default values for a predetermined time window (dTW);
calculating a new set of key performance indicators (KPIs);
determining whether a regular event or a special event has occurred;
determining, upon finding that the regular event has occurred, whether to transfer a recommended amount of funds to a recipient upon any one of the following being true: (1) a previous actual transfer amount for a regular event (act_xfer) is not less than a recommended transfer amount for a regular event (rec), and (2) the default recommended transfer amount (df_rec) is not less than the rec;
setting, upon a determination to transfer the recommended amount of funds to the recipient in response to the regular event, the act_xfer to be equal to the rec;
transferring, upon setting the act_xfer equal to the rec, the rec to the recipient;
determining, upon finding that the special event has occurred, whether to transfer the recommended amount of funds to the recipient upon any one of the following being true: (1) a previous actual transfer amount for a special event (spec_xfer) is not less than a recommended transfer amount for a special event (spec), and (2) the default recommended transfer amount for a special event (sp_df_rec) is not less than the spec;
setting, upon a determination to transfer the recommended amount of funds to the recipient in response to the special event, the spec_xfer equal to the spec;
transferring, upon setting the spec_xfer equal to the spec, the spec to the recipient; and
executing, upon a determination that neither the regular event or the special event has occurred, the analysis in a different dTW.

2. The system of claim 1, wherein the analysis further comprises:
calculating, upon a determination that the act_xfer is less than the rec, a temporary value (temp) by multiplying the act_xfer by a predetermined multiplier value (multiplier);
determining, upon calculating the temp, whether the temp is less than or equal to a maximum recommended transfer amount for a regular event (max_rec);
setting, upon determining that the temp is less than or equal to the max_rec, the rec equal to the temp;
setting, upon setting the rec equal to the temp, the rec equal to the act_xfer;
transferring, upon setting the rec equal to the act_xfer, the rec to the recipient;
setting, upon a determination that temp is not less than or equal to the max_rec, the act_xfer equal to the rec;
transferring, upon setting the rec equal to the act_xfer, the rec to the recipient; and
executing, upon transferring the act_xfer to the recipient, the analysis in a different dTW.

3. The system of claim 1, wherein the analysis further comprises:
calculating, upon a determination that the spec_xfer is less than the spec, a temporary value (temp) by multiplying the spec_xfer by a predetermined special multiplier (s_multiplier);
determining, upon calculating the temp, whether the temp is less than or equal to a maximum recommended transfer amount for a special event (smax_rec);
setting, upon determining that the temp is less than or equal to the smax_rec, the spec equal to the temp;
setting, upon setting the spec equal to the temp, the spec equal to the spec_xfer;
transferring, upon setting the spec equal to the spec_xfer, the spec to the recipient;
setting, upon a determination that temp is not less than or equal to the smax_rec, the spec_xfer equal to the spec;
transferring, upon setting the spec equal to the act_xfer, the spec to the recipient; and
executing, upon transferring the act_xfer amount to the recipient, the analysis in a different dTW).

4. The system of claim 1, wherein the analysis further comprises:
calculating, upon a determination that the df_rec is less than the rec, a temporary value (temp) by multiplying the df_rec by a predetermined multiplier (multiplier);
determining, upon calculating the temp, whether the temp is less than or equal to a maximum recommended transfer amount for a regular event (max_rec);
setting, upon determining that the temp is less than or equal to the max_rec, the rec to be equal to the temp;
setting, upon setting the rec to be equal to the temp, the act_xfer to be equal to the rec;
transferring, upon setting the act_xfer to be equal to the rec, the rec to the recipient;
setting, upon determining that the temp is not less than or equal to the max_rec, the rec to be equal to the df_rec;
transferring, upon setting the rec to be equal to the df_rec, the rec to the recipient; and
executing, upon transferring the rec to the recipient, the analysis in a different dTW.

5. The system of claim 1, wherein the analysis further comprises:
calculating, upon a determination that the sp_df_rec is not less than the spec, a temporary value (temp) by multiplying the sp_df_rec by a predetermined multiplier (s_multiplier);
determining, upon calculating the temp, whether the temp is less than or equal to a maximum recommended transfer amount for a special event (smax_rec);
setting, upon a determination that the temp is less than or equal to the smax_rec, the spec to be equal to the temp;
setting, upon setting the spec to be equal to the temp, the spec_xfer to be equal to the spec;
transferring, upon setting the spec_xfer to be equal to the spec, the spec to the recipient;
setting, upon a determination that the temp is not less than or equal to the smax_rec, the spec to be equal to the sp_df_rec;
transferring, upon setting the spec to be equal to the sp_df_rec, the spec to the recipient; and
executing, upon transferring the spec to the recipient, the analysis in a different dTW.

6. The system of claim 3, wherein the s_multiplier is the predetermined value used in recommended special event transfers.

7. The system of claim 1, wherein the rec is the recommended transfer amount for non-special events and the spec is the recommended transfer amount for special events.

8. The system of claim 1, wherein the act_xfer is a sender's actual transfer amount for non-special events in response to a recommendation and the spec_xfer is a sender's actual transfer amount for special events in response to a recommendation.

9. A method for selecting transfer amounts associated with events in dynamic lightweight personalized analytics (DLPA), the method comprising the steps of:
setting a group of metrics to their default values, the values comprising: a default recommended transfer amount (df_rec) and a default recommended transfer amount for a special event (sp_df_rec);
comparing, by a processor, the metrics against their default values for a predetermined time window (dTW);
calculating a new set of key performance indicators (KPIs);
determining whether a regular event or a special event has occurred;
determining, upon finding that the regular event has occurred, whether to transfer a recommended amount of funds to a recipient upon any one of the following being true: (1) a previous actual transfer amount for a regular event (act_xfer) is not less than a recommended transfer amount for a regular event (rec), and (2) the default recommended transfer amount (df_rec) is not less than the rec;
setting, upon a determination to transfer the recommended amount of funds to the recipient in response to the regular event, the act_xfer to be equal to the rec;
transferring, upon setting the act_xfer equal to the rec, the rec to the recipient;
determining, upon finding that the special event has occurred, whether to transfer the recommended amount of funds to the recipient upon any one of the following being true: (1) a previous actual transfer amount for a special event (spec_xfer) is not less than a recommended transfer amount for a special event (spec), and (2) the default recommended transfer amount for a special event (sp_df_rec) is not less than the spec;
setting, upon a determination to transfer the recommended amount of funds to the recipient in response to the special event, the spec_xfer equal to the spec;
transferring, upon setting the spec_xfer equal to the spec, the spec to the recipient; and
executing, upon a determination that neither the regular event or the special event has occurred, the analysis in a different dTW.

10. The method of claim 9, wherein the method further comprises the steps of:
calculating, upon a determination that the act_xfer is less than the rec, a temporary value (temp) by multiplying the act_xfer by a predetermined multiplier value (multiplier);
determining, upon calculating the temp, whether the temp is less than or equal to a maximum recommended transfer amount for a regular event (max_rec);
setting, upon determining that the temp is less than or equal to the max_rec, the rec equal to the temp;
setting, upon setting the rec equal to the temp, the rec equal to the act_xfer;
transferring, upon setting the rec equal to the act_xfer, the rec to the recipient;
setting, upon a determination that temp is not less than or equal to the max_rec, the act_xfer equal to the rec;
transferring, upon setting the rec equal to the act_xfer, the rec to the recipient; and
executing, upon transferring the act_xfer amount to the recipient, the analysis in a different dTW.

11. The method of claim 9, wherein the method further comprises the steps of:
calculating, upon a determination that the spec_xfer is less than the spec, a temporary value (temp) by multiplying spec_xfer by predetermined special multiplier (s_multiplier);
determining, upon calculating the temp, whether the temp is less than or equal to a maximum recommended transfer amount for a special event (smax_rec);
setting, upon determining that the temp is less than or equal to the smax_rec, the spec equal to the temp;
setting, upon setting the spec equal to the temp, the spec equal to the spec_xfer;
transferring, upon setting the spec equal to the spec_xfer, the spec to the recipient;
setting, upon a determination that temp is not less than or equal to the smax_rec, the spec_xfer equal to the spec;
transferring, upon setting the spec equal to the spec_xfer, the spec to the recipient; and
executing, upon transferring the spec_xfer amount to the recipient, the analysis in a different dTW).

12. The method of claim 9, wherein the method further comprises the steps of:
calculating, upon a determination that the df_rec is less than the rec, a temporary value (temp) by multiplying the df_rec by a predetermined multiplier (multiplier);
determining, upon calculating the temp, whether the temp is less than or equal to a maximum recommended transfer amount for a regular event (max_rec);
setting, upon determining that the temp is less than or equal to the max_rec, the rec to be equal to the temp;
setting, upon setting the rec to be equal to the temp, the act_xfer to be equal to the rec;
transferring, upon setting the act_xfer to be equal to the rec, the rec to the recipient;
setting, upon determining that the temp is not less than or equal to the max_rec, the rec to be equal to the df_rec;
transferring, upon setting the rec to be equal to the df_rec, the rec to the recipient; and
executing, upon transferring the rec to the recipient, the analysis in a different dTW.

13. The method of claim 9, wherein the method further comprises the steps of:
calculating, upon a determination that the sp_df_rec is not less than the spec, a temporary value (temp) by multiplying the sp_df_rec by a predetermined multiplier (s_multiplier);
determining, upon calculating the temp, whether the temp is less than or equal to a maximum recommended transfer amount for a special event (smax_rec);
setting, upon a determination that the temp is less than or equal to the smax_rec, the spec to be equal to the temp;
setting, upon setting the spec to be equal to the temp, the spec_xfer to be equal to the spec;
transferring, upon setting the spec_xfer to be equal to the spec, the spec to the recipient;
setting, upon a determination that the temp is not less than or equal to the smax_rec, the spec to be equal to the sp_df_rec;
transferring, upon setting the spec to be equal to the sp_df_rec, the spec to the recipient; and
executing, upon transferring the spec to the recipient, the analysis in a different dTW.

14. The method of claim 11, wherein the s_multiplier is the predetermined value used in recommended special event transfers.

15. The method of claim 9, wherein the rec is the recommended transfer amount for non-special events and the spec is the recommended transfer amount for special events.

16. The method of claim 9, wherein the act_xfer is a sender's actual transfer amount for non-special events in response to a recommendation and the spec_xfer is a sender's actual transfer amount for special events in response to a recommendation.

17. A system for associating recommended transfers with a predetermined group of key performance indicators (KPIs), the system comprising:
an interface that receives one or more inputs via an enterprise payment services bus;
a data storage unit comprising a customer account database and a trends database, wherein the customer account database is further configured to store at least account profiles, support data, DLPA metrics, and key performance indicators (KPIs); and
a remittance analytics engine comprising a computer processor and coupled to the data storage unit and the interface, the computer processor configured to perform an analysis to associate recommended transfers with the KPIs, the analysis comprising:
setting a group of relevant metrics to their default values;
execute an analysis of the KPIs over a predetermined time window (dTW);
calculating, within the dTW, a new set of KPIs;
determining whether at least X number of KPIs are favorable, wherein X is a default parameter;
executing, upon a determination that at least X number of KPIs are favorable, a process for making recommendations associated with transfers between a sender and a recipient; and
executing, upon a determination that less than X number of KPIs are favorable, an analysis of the KPIs over a different dTW.

18. The system of claim 17, wherein dTW is a default time frame for calculating parameters and making decisions.

19. A method for associating recommended transfers with key performance indicators (KPIs), the method comprising the steps of:
setting a group of relevant metrics to their default values;
execute an analysis of the KPIs over a predetermined time window (dTW);
calculating, within the dTW, a new set of KPIs;
determining whether at least X number of KPIs are favorable, wherein X is a default parameter;
executing, upon a determination that at least X number of KPIs are favorable, a process for making recommendations associated with transfers between a sender and a recipient; and
executing, upon a determination that less than X number of KPIs are favorable, an analysis of the KPIs over a different dTW.

20. The method of claim 19, wherein dTW is a default time frame for calculating parameters and making decisions.
